(19) United States
(12) Patent Application Publication
(10) Pub. No.: US 2005/0157355 A1
(43) Pub. Date: Jul. 21, 2005

(54) Image scanning apparatus capable of operating in transparent scanning mode or reflective scanning mode

(75) Inventor: Sun Tao, Su Zhou City (CN)

Correspondence Address: Richard P. Berg, Esq.;c/o LADAS & PARRY, Suite 2100, 5670 Wilshire Boulevard, Los Angeles, CA, 90036-5679, US

(73) Assignee: BENO CORPORATION

(21) Appl. No.: 11/035,246

(22) Filed: Jan. 12, 2005

(30) Foreign Application Priority Data
Jan. 16, 2004 (TW) 093101265

(51) Int. Cl. H04N 1/04

(52) U.S. Cl. 358/487; 358/509

(57) ABSTRACT

The invention provides an image scanning apparatus, capable of operating in a transparent-scanning mode or a reflective-scanning mode, and a control procedure thereof. The image scanning apparatus of the present invention has the capability of actively judging whether to use the transparent-scanning mode or the reflective-scanning mode. Moreover, in the control procedure of the scanning image apparatus of the invention, the determination of whether using a positive film processing mode or a negative film processing mode is performed when the image scanning apparatus is confirmed to operate in the transparent-scanning mode.

### BACKGROUND OF THE INVENTION

1. Field of the Invention

The present invention relates to an image scanning apparatus and a control method thereof, and more particularly, to an image scanning apparatus capable of operating in a transparent-scanning mode or a reflective-scanning mode.

2. Description of the Prior Art

As shown in FIGS. 1A and 1B, most of the typical image scanning apparatuses, of the prior art, capable of operating in a transparent-scanning mode or a reflective-scanning mode have two light sources. As in typical image scanning apparatus, the image scanning apparatus 1, shown in FIGS. 1A and 1B, includes a housing 10, a transparent platform 102, a first light source 122 disposed in a cover 12, a second light source 144 disposed in the housing 10, an image sensor 105 disposed in the housing 10, a controller 106, and a processor 107. The transparent-platform 102 is mounted onto top surface of the housing 10 to place thereon an object to be scanned.

The first light source 122 disposed in cover 12 is used for transparent-scanning mode. Because most users do not often use the image scanning apparatus 1 in transparent-scanning mode, the cover 12 is usually designed to be detachable to the housing 10. As shown in FIG. 1A, the cover 12 engaged to the housing 10 also connects to the power and related control elements (e.g., the controller 106) inside the housing 10 through a cable 108, so as to accept power and control signals or to transmit signals.

When the image scanning apparatus 1 is operated in the transparent-scanning mode, the controller 106 controls the first light source 122 in the cover 12 to provide a light beam projected towards the object to be scanned on the platform 102. When the image scanning apparatus 1 is operated in the reflective-scanning mode, the controller 106 controls the second light source 104 in the housing 10 to provide a light beam projected towards the object to be scanned on the platform 102. In the operations of both scanning modes, the controller 106 controls the image sensor 105 to sense (scan) an image associated with the object to be scanned. The processor 107 processes the image scanned by the image sensor 105.

Generally, the transparent-scanning mode is the mode used to scan an object that is a positive or a negative film. Therefore, the image scanning apparatus 1 includes a holder 14 to hold an object to be scanned, as shown in FIG. 1A. The holder 14 is a board-shaped component, which includes a first frame 142 and a second frame 144. The first frame 142 is a three dimensional (3D) frame embossed on the holder 14. The first frame 142 is adapted to hold a positive film to be scanned, so that the positive film can be horizontally placed in the predetermined position on the transparent platform 102 to allow the image sensor 105 to scan the image. The second frame 144 is also a 3D frame embossed on the holder 14. The second frame 144 is adapted to hold a negative film to be scanned, so that the negative film can be horizontally placed in the predetermined position on the transparent platform 102 to allow the image sensor 105 to scan the image. The second frame 144 is disposed in a position opposite to the first frame 142.

The holder 14 is detachably engaged to the cover 12 and disposed on the platform 102. When the object to be scanned is a positive film, the holder 14 is engaged to the cover 12, so as to allow the positive film held by the first frame 142 to be positioned in a predetermined scan area for positive films defined by the image scanning apparatus 1. On the other hand, when the object to be scanned is a negative film, rotating the holder 14 for 180 degrees along the normal axis of the board-shaped holder 14, and engaging the holder 14 to the cover 12, so as to allow the negative film held by the second frame 144 to be positioned in a predetermined scan area for negative films defined by the image scanning apparatus 1.

As shown in FIG. 1A, the image scanning apparatus 1 also includes a first tag switch 124 and a second tag switch 126 mounted on the cover 12, in order to activate the transparent-scanning mode and to determine whether the object to be scanned is a positive film or a negative film. Normally, the first tag switch 124 and the second tag switch 126 are both in an open circuit. The holder 14 includes a first formed-through hole 146 corresponding to the first frame 142 and a second formed-through hole 148 corresponding to the second frame 144.

When the holder 14 is engaged to the cover 12, and the cover 12 is placed down, the first tag switch 124 will be enabled by the holder 14 to become a closed circuit and then output a first selection signal. The second tag switch 126 will pass through the first formed-through hole 146 and be kept in an open circuit. At this moment, if the image scanning apparatus 1 receives an operation command from a user, the controller 106 will be controlled by the first selection signal to control the image sensor 105, incorporating with the first light source 122, to scan the image associated with the object to be scanned. Such an operation is in the transparent-scanning mode. Meanwhile, the controller 106 also controls the processor 107 to process the image associated with the object to be scanned in the positive film mode.

When the holder 14 is engaged to the cover 12 after rotating for 180 degree, and the cover 12 is placed down, the second tag switch 126 will be enabled by the holder 14 to become a closed circuit and then output a second selection signal. The first tag switch 124 will pass through the second formed-through hole 148 and be kept in an open circuit. At this moment, if the image scanning apparatus 1 receives an operation command from a user, the controller 106 will be controlled by the second selection signal to control the image sensor 105, incorporating with the first light source 122, to scan the image associated with the object to be scanned. Such an operation is in the transparent-scanning mode. Meanwhile, the controller 106 also controls the processor 107 to process the image associated with the object to be scanned in a negative film mode.

Similar to the image scanning apparatus 1, other image scanning apparatus with both transparent-scanning mode and reflective-scanning mode, according to the prior art, includes a first contact switch and a second contact switch installed on the cover to replace the first tag switch and the second tag switch of the image scanning apparatus 1 respectively. Such image scanning apparatus also includes a first electric-conduction element corresponding to the first contact switch and a second electric-conduction element corresponding to the second contact switch to replace the formed-through holes installed on the holder of the image scanning apparatus. The first contact switch outputs a third selection signal in response to the contact by the first electric-conduction element. The second contact switch outputs a forth selection signal in response to the contact by the second electric-conduction element.

No matter which kind of image scanning apparatus mentioned above, according to the image scanning apparatus with transparent-scanning mode and reflective-scanning mode of the prior art, the first step in the control flow is to determine whether it is in a positive film mode or a negative film mode. If the image scanning apparatus determines that it is in the positive film mode, then the operation is in the transparent-scanning mode. If the image scanning apparatus determines that it is in the negative film mode, then the operation is in the transparent-scanning mode. If the image scanning apparatus determines that it is neither in a positive film mode nor a negative film mode, then the operation is in the reflective-scanning mode.

Obviously, the image scanning apparatus capable of transparent-scanning mode and reflective-scanning mode of the prior art can not voluntarily determine whether it is the transparent or the reflective scanning mode. When changing from the transparent-scanning mode to the reflective-scanning mode, most of the time, the user only removes the cover with the holder from the housing, without removing the cable connected to the housing and the cover. As a result, when the image scanning apparatus receives the operation command from the user, the image scanning apparatus will determine that it is either in the positive film mode or the negative film mode, so that the operation is in the transparent-scanning mode.

### SUMMARY OF THE INVENTION

An objective of the present invention is to provide an image scanning apparatus, which is capable of operating in a transparent-scanning mode or a reflective-scanning mode. More particularly, the image scanning apparatus of the present invention can voluntarily determine whether it is in a transparent-scanning mode or in a reflective-scanning mode.

Moreover, another objective of the present invention is to provide an image scanning apparatus, in which its first step of the control flow is to determine whether to operate in the transparent-scanning mode or the reflective-scanning mode. If it determines that the operation is in the transparent-scanning mode, it will further determine whether to operate in the positive film mode or in the negative film mode.

In a first preferred embodiment, the present invention provides an image scanning apparatus including a housing, a transparent platform, a cover, a first light source, a second light source, a signal transmitter, a signal receiver, and a controller. The transparent platform is mounted onto the housing for placing thereon an object to be scanned. The cover is detachably connected to the housing. The first light source is disposed in the cover. The second light source is disposed in the housing. The signal transmitter is used to transmit an active signal. The signal receiver is used to receive the active signal and output a first selection signal responsive to the active signal when the cover is connected to the housing and positioned in a closed position with respect to the housing. The controller is used for, based on the first selection signal, selectively controlling the first light source or the second light source to provide a light beam towards an object to be scanned on the platform.

In the second preferred embodiment, the present invention provides an image scanning apparatus including a housing, a transparent platform, a cover, a first light source, a second light source, a boss, a switching device, an image sensor, and a controller. The transparent platform is mounted onto the housing for placing thereon an object to be scanned. The cover is detachably connected to the housing. When the cover connects to the housing, the cover can move between an open position and a closed position with respect to the housing. The first light source is disposed in the cover. The second light source is disposed in the housing. The switching device is mounted on the housing. The switching device is enabled by the boss to output a first selection signal when the cover moves from the open position to the closed position. The image sensor is installed in the housing. Based on the first selection signal, the controller controls the image sensor selectively, incorporating with the first light source or the second light source, to scan an image associated with the object to be scanned.

In another preferred embodiment, the present invention provides a control method for an image scanning apparatus including a housing, a cover, a first light source disposed in the cover, and a second light source disposed in the housing. In the control method, an operation command is first received from a user to perform scanning. Then, the cover is being determined whether it is positioned at a closed position with respect to the housing. If the result of the judgment in the above step is YES, the first light source is selected as a scanning light source for the image scanning apparatus. If the result is NO, the second light source is selected as the scanning light source for the image scanning apparatus.

In another preferred embodiment, the present invention provides a control method for an image scanning apparatus. In the control method, an operation command is first received from a user to perform scanning. Then, it is determined whether the first selection signal is generated. The first signal is generated selectively for judging whether it is a transparent-scanning mode or a reflective-scanning mode. If the result of the judgment is that the first signal is generated, the first light source is controlled to provide a light beam towards the object to be scanned on the platform. If the result of the judgment is that the first signal is not generated, the second light source is controlled to provide a light beam towards the object to be scanned on the platform. After the step of controlling the first light source to provide light beam towards the object to be scanned on the platform, it is further determined whether the second selection signal is generated. The second signal is generated selectively for judging whether it is a positive film mode. If the second signal is generated, the object to be scanned is scanned in a positive mode. If the second signal is not generated, then it is determined whether the third signal is generated. The third signal is generated selectively for judging whether it is a negative mode. If the third signal is generated, the object to be scanned is scanned in a negative film mode.

The advantage and spirit of the invention may be understood by the following recitations together with the appended drawings.

### BRIEF DESCRIPTION OF THE APPENDED DRAWINGS

FIG. 1A is a schematic diagram of a typical scanning apparatus capable of transparent-scanning and reflective-scanning mode.

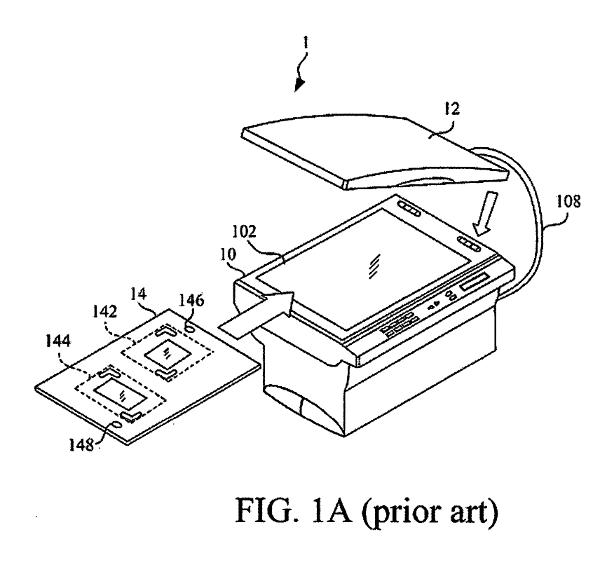

FIG. 1B is the function block diagram of the typical scanning apparatus shown in FIG. 1A.

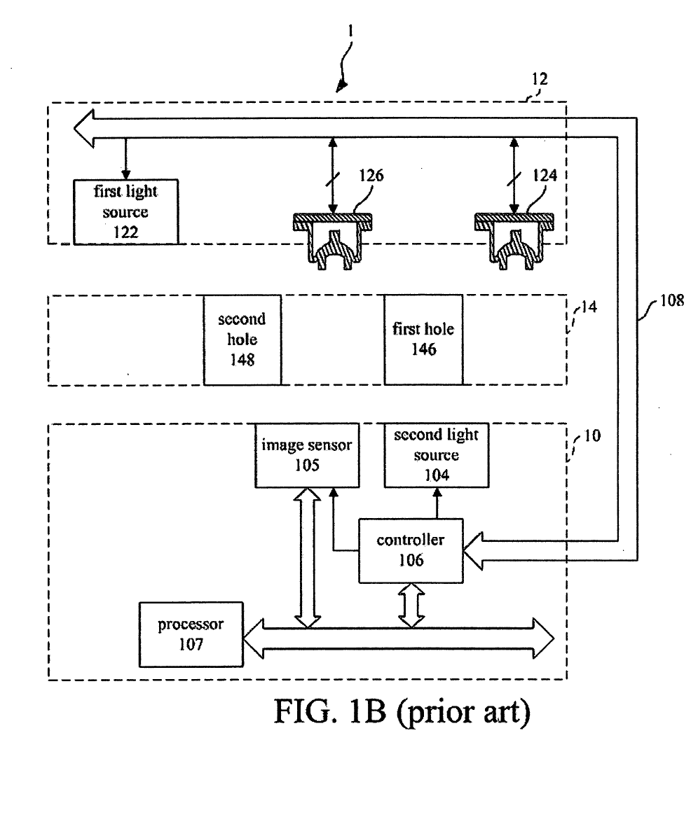

FIG. 2A is a schematic diagram of the image scanning apparatus according to the first preferred embodiment of the present invention.

FIG. 2B is the function-block diagram of the image scanning apparatus shown in FIG. 2A.

FIG. 3A is a schematic diagram of the image scanning apparatus according to the second preferred embodiment of the present invention.

FIG. 3B is the function-block diagram of the image scanning apparatus shown in FIG. 3A.

FIG. 4 is a flow chart of the image scanning method according to a preferred embodiment of the present invention.

FIG. 5 is another flow chart of the image scanning apparatus according to a preferred embodiment of the present invention.

### DETAILED DESCRIPTION OF THE PREFERED EMBODIMENT

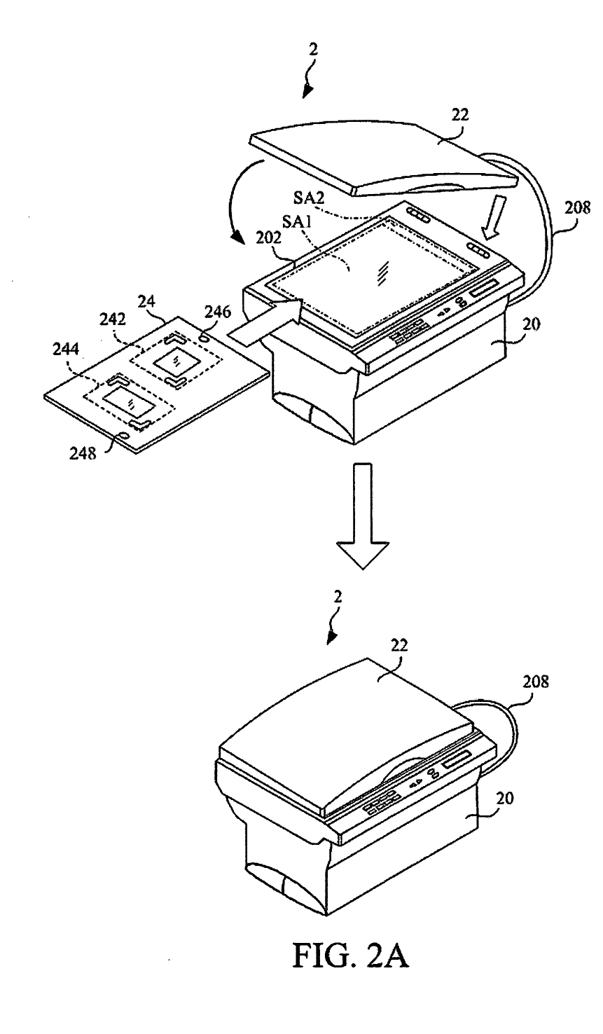

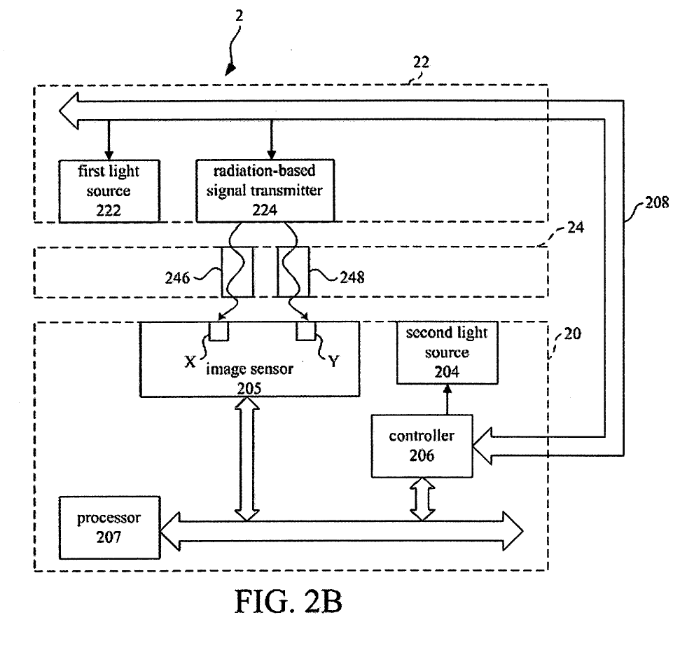

Please refer to FIGS. 2A and 2B, an image scanning apparatus according to a first preferred embodiment of the invention is illustrated. FIG. 2A is a schematic diagram of the image scanning apparatus according to the first preferred embodiment of the present invention. FIG. 2B is the function-block diagram of the image scanning apparatus shown in FIG. 2A.

As shown in FIGS. 2A and 2B, the image scanning apparatus 2 according the first embodiment of the invention includes a housing 20, a transparent platform 202, a first light source 222 disposed in the cover 22, a second light source 204 disposed in the housing 20, an image sensor 205 disposed in the housing 20, a controller 206, and a processor 207. The transparent platform 202 is mounted on the housing 20 to place an object to be scanned.

The first light source 222 disposed in the cover 22 is used for a transparent-scanning mode. The cover 22 is detachably connected to the housing 20. As shown in FIG. 2A, the cover 22 is mounted to the housing 20, and connected via a cable 208 to the power and the controlling elements in the housing 20, e.g., the controller 206, to accept power and control signals or to transmit signals.

When the image scanning apparatus 2 is operated in the transparent-scanning mode, the controller 206 controls the first light source 222 in the cover 22 to provide a light beam towards the object to be scanned on the platform 202. When the image scanning apparatus 2 is operated in the reflective-scanning mode, the controller 206 controls the second light source 204 in the housing 20 to provide a light beam towards the object to be scanned on the platform 202. In the operations of both scanning modes, the controller 206 controls the image sensor 205 to sense (scan) an image associated with the object to be scanned. The processor 207 processes the image scanned by the image sensor 205.

More particularly, the image scanning apparatus 2 also includes a signal transmitter and a signal receiver. The transmitter transmits an active signal. Moreover, when the cover 22 is positioned at the closed position with respect to the housing 20, the transmitter receives active signal and generates a first selection signal in response to the active signal. Please refer to FIG. 2A for the closed position of the cover 22 with respect to the housing 30.

The controller 206, based on the first selection signal, selectively controls the first light source 222 or the second light source 204 to provide a light beam towards the object to be scanned on the platform 202. That means if the image scanning apparatus 2 receives an operation command from the user, the controller 206 receives a first selection signal and controls the first light source 222 to provide a light beam to scan the object to be scanned on the platform 202. On the other hand, if the controller 206 does not receive the first selection signal, the controller 206 controls the second light source 204 to provide a light beam to scan the object to be scanned on the platform 202. The processor 207 processes the image associated with the object to be scanned.

In an embodiment, the signal transmitter is a radiation-based signal transmitter. The active signal is a radiation beam. The signal receiver is a radiation-based signal receiver. In an embodiment, the radiation-based signal transmitter is disposed in the housing 20, and the radiation-based signal receiver is disposed in the cover 22. In an embodiment, the radiation beam is an infrared beam, and the radiation transmitter is an infrared transmitter. The radiation receiver is an infrared receiver.

In another embodiment, the radiation-based transmitter is disposed in the cover 22 as in the radiation-based transmitter 224 shown in FIG. 2B. The radiation-based receiver is disposed in the housing 20. In an embodiment, the radiation beam is an infrared beam; the radiation transmitter 224 is an infrared transmitter, and the radiation-based receiver is an infrared receiver.

In another embodiment, as shown in FIG. 2B, the radiation-based receiver in the housing 20 is the same component as the image senor 205. That means that the controller 206, controlled by the first selection signal, controls the image sensor 205 selectively to cooperate with the first light source or the second light source to scan an image associated with the object to be scanned. In this embodiment, the radiation beam generated by the radiation-based transmitter 224 tries to distinguish itself from the background light in order to avoid causing misjudgments from the image sensor. Therefore, the radiation-based transmitter 224 transmits the radiation beam in a fixed period. For example, the radiation-based transmitter 224 transmits a blue light in a fixed period, and the image sensor 205 and the relative electric circuit can filter the blue light in a fixed period. When a fixed-period blue light is received, the image sensor 205 starts to transmit the first selection signal.

In the above embodiment, as shown in FIG. 2, a scanning area SA1 and a calibration area SA2 are defined in the image scanning apparatus 2. The image sensor 205 is operated in the scanning area SA1 to scan the image associated with the object to be scanned, and the image sensor 205 is operated in the calibration area SA2 to receive the radiation beam.

In an embodiment, the image scanning apparatus 2 further includes a holder 24 as shown in FIG. 2A. The holder 24 is detachably engaged to the cover 22 and disposed on the transparent platform 202. The holder 24 is used for holding the scanning object to be scanned. When the holder 24 is engaged to the cover, the holder 24 provides at least one window through which the radiation beam passes. Furthermore, the cover 22 thereon provides at least one opening (not shown in FIG. 2) corresponding to the window, through which the radiation beam passes out of the cover 22 and through the corresponding window.

Also, about the embodiment above, the holder 24 provides a first frame 242 and a second frame 244. The second frame 244 is disposed in an opposite position with respect to the first frame 242, and the first frame 242 is adapted to hold the object to be scanned when the object is a positive film. The second frame 244 is adapted to hold the object to be scanned when the object is a negative film. When the object to be scanned is a positive film, the holder 24 can be engaged to the cover 22 to place the positive film on the predetermined scanning area for a positive film, defined by the image scanning apparatus 2. On the other hand, if the object to be scanned is a negative film, the holder 24 will be engaged to the cover 20 after rotating for 180 degree, so as to allow the negative file to be positioned in a predetermined scan area for negative films, defined by the image scanning apparatus 2.

Also in the above embodiment, as shown in FIG. 2A, the at least one window includes a first window 246 corresponding to the first frame 242 and a second window 248 corresponding to the second frame 244. In this embodiment, the radiation-based receiver is the image sensor 205, and it is also a linear image sensor, such as a CCD (Charge coupled device). When the image sensor 205 receives the radiation beam transmitted through the first area corresponding to the first window 246, the image sensor 205 outputs a second selection signal in response to the received radiation beam. That means, as shown in FIG. 2B, when the image sensor 205 is in the calibration area SA2, the image sensor 205 and the relative electric circuit outputs the second selection signal when the sensor object X on the first window 246 receives the radiation beam.

When the image sensor 205 receives the radiation beam transmitted through the second area corresponding to the second window 248, the image sensor outputs a third selection signal in response to the received radiation beam. That means, as shown in FIG. 2B, when the image sensor 205 is in the calibration area SA2, the image sensor 205 and relative electric circuit output the third selection signal when the sensor object Y on the second window 248 receives the radiation beam.

Moreover, when the controller 206 controls the image sensor 205 to cooperate with the first light source 222 to provide a light beam to the object to be scanned, the controller 206, based on the second selection signal or the third selection signal, further controls the processor 207 to selectively process the image associated with the object to be scanned in a positive film mode or a negative film mode. That means, if the controller 206 receives the second selection signal, the controller 206 controls the processor 207 to scan the image associated with the object to be scanned in a positive mode. On the other hand, if the controller 206 receives the third selection signal, the controller 206 controls the processor 207 to scan the image associated with the object to be scanned in a negative mode.

In actual application, if the second selection signal is generated, the second selection signal can be combined with the first selection signal into one signal, and then the combined signal will be outputted by the image sensor 205. If the third selection is generated, the third selection signal can be combined with the first selection signal into one signal, and then the combined signal will be outputted by the image sensor 205.

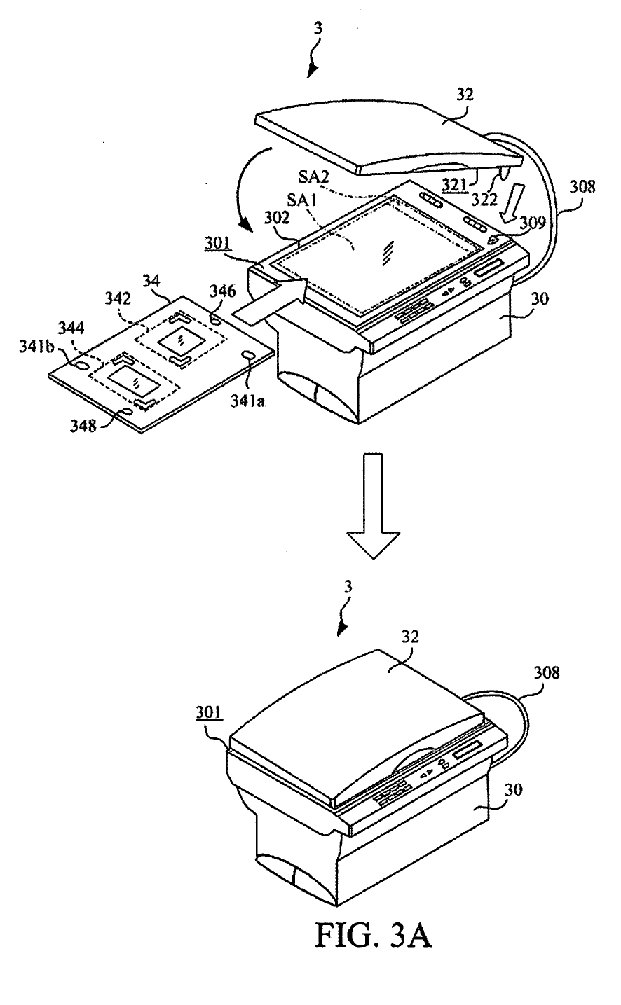

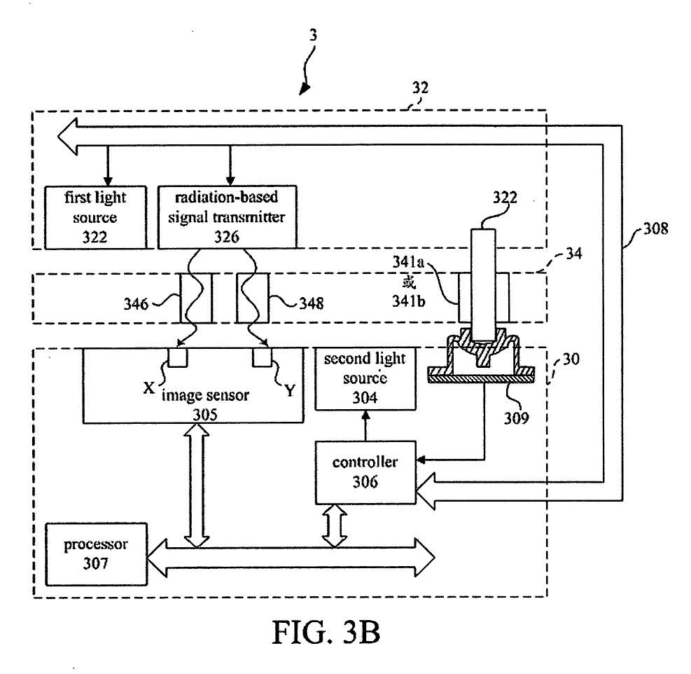

Referring to FIGS. 3A and 3B, an image scanning apparatus according to the second preferred embodiment of the invention is illustrated. FIG. 3A is a schematic diagram of the image scanning apparatus according to the second preferred embodiment of the present invention. FIG. 3B is the function-block diagram of the image scanning apparatus shown in FIG. 3A.

As shown in FIGS. 3A and 3B, the image scanning apparatus 3 includes a housing 30, a transparent platform 302, a cover 32 which has a first light source 322 disposed inside, a second light source 304 disposed in the housing 30, an image sensor 305 disposed in the housing 30, a controller 306, and a processor 307. The transparent platform 302 is mounted on the top surface 301 of the housing 30 for placing an object to be scanned.

The first light source 322 in the cover 32 is used for a transparent-scanning mode. The cover 32 is detachably engaged to the housing 30. When the cover 32 connects to the housing 30, as shown in FIG. 3A, the cover 32 can move between an open position and a closed position with respect to the housing. Please refer to FIG. 3A for the closed position of the cover 32 with respect to the housing 30.

As shown in FIG. 3A, the cover 32 is engaged to the housing 30, and connected via a cable 308 to the power and the controlling elements in the housing 30, e.g., the controller 306, so as to receive power and control signals or to transmit signals.

When the image scanning apparatus 3 is operated in the a transparent-scanning mode, the controller 306 controls the first light source 322 in the cover 32 to provide a light beam towards the object to be scanned on the platform 302. When the image scanning apparatus 3 is operated in the reflective-scanning mode, the controller 306 controls the second light source 304 in the housing 30 to provide a light beam towards the object to be scanned on the platform 302. In the operations of both scanning modes, the controller 306 controls the image sensor 305 to sense (scan) an image associated with the object to be scanned while the processor 307 processes the image scanned by the image sensor 305.

More particularly, the image scanning apparatus 3 also includes a boss and a switching device. Furthermore, when the cover 32 is moving from an open position to a closed position, the switching device is activated by the boss and outputs the first selection signal.

The controller 306, based on the first selection signal, selectively controls the first light source 322 or the second light source 304 to provide a light beam towards the object to be scanned on the platform 202. That means, if the image scanning apparatus 3 receives an operation command from the user, and the controller 306 receives the first selection signal at the time, it controls the first light source 322 to provide a light beam toward the object to be scanned on the platform 302. On the other hand, if the controller 306 does not receive the first selection signal at that time, the controller 306 controls the second light source 304 to provide a light beam toward the object to be scanned on the platform 302. The processor 307 processes the image associated with the object to be scanned.

In an embodiment, the cover 32 defines a bottom surface 321 corresponding to the top surface 301 of the housing 301. As shown in FIG. 3A, the boss 322 extends from the bottom surface 321, and the switch device is thereon disposed on the top surface 301 of the housing 30. In another embodiment, the switch device is disposed on the bottom surface 301, and the boss extends from the top surface 301 of the housing 30.

In an embodiment, the image scanning apparatus 3 further includes a holder 34, as shown in FIG. 3A. The holder 34 is detachably engaged to the cover 32 and is disposed on the platform 302. The holder 34 is used for holding the object to be scanned. When the holder 34 is engaged to the cover 32, the holder provides at least one formed-through holes (labeled as 341a and 341b shown in FIG. 3A) for the boss to pass through.

In the above embodiment, the holder 34 provides a first frame 342 and a second frame 344. The second frame 344 is in the opposite position with respect to the first frame 342. The first frame is adapted to hold the object to be scanned when the object is a positive film. The second frame is adapted to hold the object to be scanned when the object is a negative film. When the object to be scanned is a positive film, the holder 34 is engaged to the cover 32, so as to allow the positive film held by the first frame 342 to be positioned in a predetermined scan area for positive films, defined by the image scanning apparatus 3. On the other hand, when the object to be scanned is a negative film, the holder 34 is engaged to the cover 32 after rotating for 180 degree, so as to allow the negative film held by the second frame 344 to be positioned in a predetermined scan area for negative film, defined by the image scanning apparatus 3.

In the above embodiment, the at least one window includes a first window 346 corresponding to the first frame 342 and a second window 348 corresponding to the second frame 344. The image scanning apparatus 3 further includes a radiation-based signal transmitter 326. The radiation-based signal transmitter 326 is disposed in the cover 32 for generating a radiation beam. In this embodiment, the radiation-based receiver is the image sensor 305, and it is also a linear image sensor, such as a CCD. When the image sensor 305 receives a radiation beam transmitted from a first location corresponding to the first window 346, the image sensor 305 outputs a second selection signal in response to the received radiation beam. That is, as shown in FIG. 3B, when the image sensor 305 and relative electric circuit determines that the sensor object X corresponding from the first window 346 receives the radiation beam, the image sensor 305 and relative electric circuit outputs a second selection signal in response to the radiation beam. When the image sensor 305 receives the radiation beam transmitted from the second position corresponding to the second window 348, the image sensor 305 outputs a third selection signal in response to the received radiation beam. That is, as show in FIG. 3B, the image sensor 305 and relative electric circuit outputs the third selection signal when the sensor object Y on the second window 348 receives the radiation beam. Moreover, when the control 306 controls the image sensor 305 to cooperate with the first light source 322 to scan the image associated with the object to be scanned, the controller 306, based on the second selection signal or the third selection signal, further controls the processor 307 to selectively process the image associated with the object to be scanned in a positive film mode or in a negative film mode. That means, if the controller 306 receives the second selection signal, the controller 306 controls the processor 307 to scan the image associated with the object to be scanned in a positive mode. On the other hand, if the controller 306 receives the third selection signal, the controller 306 controls the processor 307 to scan the image associated with the object to be scanned in a negative mode.

In this above embodiment, to distinguish the radiation beam from the background light in order to avoid causing misjudgments from the image sensor, the radiation-based transmitter 224 transmits the radiation beam in a fixed period. For example, the radiation-based transmitter 324 transmits a fixed-period blue light, and the image sensor 305 and the relative electric circuit can filter the fixed-period blue light. When a fixed-period blue light is received, the image sensor 205 starts to transmit the first selection signal.

In the same embodiment above, as shown in FIG. 3A, a scanning area SA1 and a calibration area SA2 are defined in the image scanning apparatus 3. The image sensor 305 is operated to scan the image associated with the object to be scanned in the scanning area SA1 and to receive the radiation beam in the calibration area SA2.

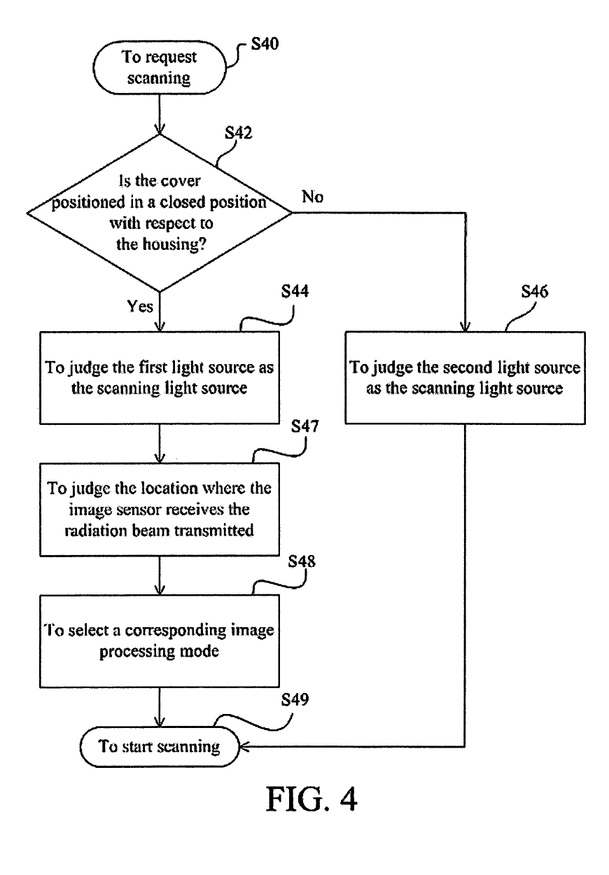

Referring to FIG. 4, the flow chart of the image scanning method according to a preferred embodiment of the invention is illustrated. The image scanning apparatus for the controlling method shown in FIG. 4 includes a housing, a cover, a first light source disposed in the cover, and a second light source disposed in the housing.

First, in step S40, an operation command from a user is received, and scanning is requested. Then, in step S42, it is determined whether the cover is in a closed position in respect to the housing. If step S42 is YES, then in step S44, the image scanning apparatus uses the first light source as the scanning light source. If step S42 is NO, then in step S46, the image scanning apparatus uses the second light source as the scanning light source.

In an embodiment, the image scanning apparatus also includes a signal transmitter and a signal receiver. The signal transmitter transmits an active signal. The signal receiver selectively receives the active signal and outputs a first selection signal in response to the received active signal. In step S42, the judgment about whether the cover is positioned at the closed position in respect to the housing is determined by whether the first selection signal is generated. In an embodiment, the signal transmitter is disposed in the housing, and the signal receiver is disposed in the cover. In another embodiment, the signal transmitter is disposed in the cover, and the signal receiver is disposed in the housing.

In an embodiment, the signal transmitter is a radiation-based signal transmitter. The active signal is a radiation beam. The signal receiver is a radiation-based signal receiver. In another embodiment, the radiation-based receiver is an image sensor in the image scanning apparatus. In this embodiment, step S44 also performs the controlling of the image sensor to cooperate with the first light source to scan an image associated with the object to be scanned. In step S46, it also performs the controlling of the image sensor to cooperate with the second light source to scan an image associated with the object to be scanned.

In an embodiment, after step S44, in a further step S47, the position of the radiation received by the image sensor is being determined. After step S46 following with step S48, a corresponding image scanning mode is selected to scan the object to be scanned according to step S47. After S48 and S46, following with step S49, scanning is performed under all the pre-defined conditions.

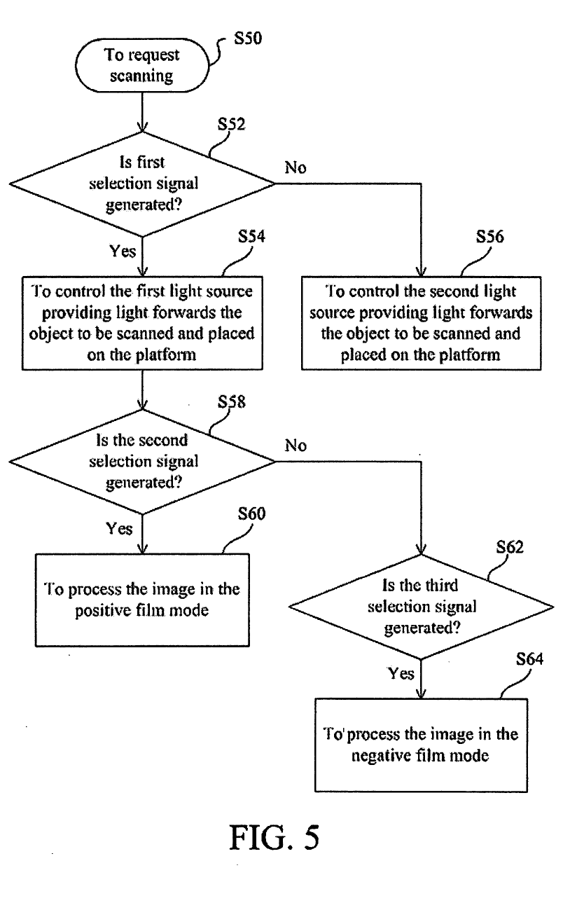

Please refer to FIG. 5, which is the flow chart of another embodiment of the present invention. A first selection signal is generated selectively in response to the cover being in the closed position with respect to the housing. Furthermore, the decision of whether to operate in transparent-scanning mode or reflective-scanning mode is determined according to the first selection signal.

First, in step S50, an operation from the user is received, and scanning is requested. Then in step S52, it is determined whether the first selection signal is generated. If YES in step S52, then step S54 is performed, where the first light source is controlled to provide a light beam to the object to be scanned on the platform. If NO in step S52, then step S56 is performed, where the second light source is controlled to provide a light beam to the object to be scanned on the platform.

In an embodiment, the first selection signal is generated by the radiation-based receiver in response to receiving the radiation beam transmitted by the radiation-based transmitter. Related details will not be repeated here.

In another embodiment, the first selection signal is generated by the switch device that was activated by the boss, in the second preferred embodiment according the present invention. Related details will not be repeated here.

In another embodiment, a second selection signal is generated selectively. The second selection signal is used for judging whether to operate in the positive film mode. A third selection signal is also selectively generated for judging whether to operate in the negative film mode. After step S54, step S58 is performed to determine whether the second selection signal is generated. If YES in step S58, then in step S60, the object to be scanned is scanned in positive film mode. If NO in step S58, then in step S63, it is determined whether the third signal is generated. If YES in step S62, then in step S64, the object to be scanned is scanned in negative film mode. The generating of the second selection signal and third selection signal has been mentioned in the first preferred embodiment and second preferred embodiment of the present invention, so it will not be described here.

Beside the two preferred embodiment mentioned above, the second selection signal and the third selection signal can also be generated by the contact switch device by contacting with electric-conducted objects. This can be generated by another radiation-based transmitter and another radiation-based receiver or generated by the pressed switch device to enable it.

Obviously, the image scanning apparatus has the capability of automatically judging whether to use a transparent-scanning mode or a reflective-scanning mode. Moreover, in the control method for the image scanning apparatus of the present invention, the determination of whether using a positive film processing mode or a negative film processing mode is performed when the image scanning apparatus is confirmed to operate in a transparent-scanning mode.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. An image scanning apparatus, comprising:
a housing;
a cover for covering the housing;
a first light source disposed in the cover;
a signal transmitter for transmitting an active signal;
a signal receiver for receiving the active signal and outputting a first selection signal responsive to the active signal, when the cover is positioned in a closed position with respect to the housing; and
a controller, based on the first selection signal, for selectively controlling the first light source as a scanning light source for said image scanning apparatus.

2. The image scanning apparatus of claim 1, wherein the signal transmitter is a radiation-based signal transmitter, the active signal is radiation beam, and the signal receiver is a radiation-based signal receiver.

3. The image scanning apparatus of claim 2, wherein the radiation-based signal transmitter is disposed in the housing, and the radiation-based signal receiver is disposed in the cover.

4. The image scanning apparatus of claim 2, wherein the radiation-based signal transmitter is disposed in the cover, and the radiation-based signal receiver is disposed in the housing.

5. The image scanning apparatus of claim 4, further comprising:
a transparent platform, mounted onto the housing, for placing thereon an object to be scanned; and
a second light source disposed in the housing;
wherein the radiation-based receiver is an image sensor of said image scanning apparatus, the controller, based on the first selection signal, controls the image sensor selectively incorporating with the first light source or the second light source to scan an image associated with the object to be scanned.

6. The image scanning apparatus of claim 5, wherein the radiation-based transmitter transmits the radiation beam in a fixed period.

7. The image scanning apparatus of claim 6, wherein a scanning area and a calibration area are defined in said image scanning apparatus, the image sensor is operated in the scanning area to scan the image associated with the object to be scanned, and in the calibration area to receive the radiation beam transmitted from the radiation-based signal transmitter.

8. The image scanning apparatus of claim 7, further comprising a holder, detachably engaged to the cover and disposed on the transparent platform, for holding the object to be scanned, wherein when the holder is engaged to the cover, the holder provides at least one window through which the radiation beam passes.

9. The image scanning apparatus of claim 8, wherein the holder thereon provides a first frame and a second frame disposed opposite to the first frame, the first frame is adapted to hold the object to be scanned when the object is a positive film, the second frame is adapted to hold the object to be scanned when the object is a negative film, the at least one window comprises a first window corresponding to the first frame and a second window corresponding to the second frame, when the image sensor receives the radiation beam transmitted at a first location corresponding to the first window, the image sensor outputs a second selection signal in response to the received radiation beam, when the image sensor receives the radiation beam transmitted at a second location corresponding to the second window, the image sensor outputs a third selection signal in response to the received radiation beam, said image scanning apparatus further comprises:
a processor, disposed in the housing, for processing the image associated with the object to be scanned; and
wherein when the controller controls the image sensor incorporating with the first light source to scan the image associated with the object to be scanned, the controller further, based on the second selection signal or the third selection signal, controls the processor to selectively process the image associated with the object to be scanned in a positive film mode or a negative film mode.

10. An image scanning apparatus, comprising:
a housing;
a cover capable of moving between an open position and a closed position with respect to the housing;
a boss;
a first light source disposed in the cover;
a switching device which is actuated by the boss to output a first selection signal when the cover moves from the open position to the closed position;
a controller, based on the first selection signal, for selectively controlling the first light source as a scanning light source for said image scanning apparatus.

11. The image scanning apparatus of claim 10, further comprising:
a transparent platform, mounted onto a top surface of the housing, for placing thereon an object to be scanned; and
a holder, detachably engaged to the cover and disposed on the transparent platform, for holding the object to be scanned;
wherein when the holder is engaged to the cover, the holder provides at least one formed-through hole through which the boss passes.

12. The image scanning apparatus of claim 11, wherein the holder thereon provides a first frame and a second frame disposed opposite to the first frame, the first frame is adapted to hold the object to be scanned when the object is a positive film, the second frame is adapted to hold the object to be scanned when the object is a negative film, the holder also has a first window corresponding to the first frame and a second window corresponding to the second frame, said image scanning apparatus further comprises:
a second light source disposed in the housing;
a radiation-based signal transmitter, disposed in the cover, for transmitting a radiation beam;
an image sensor disposed in the housing, wherein the controller, based on the first selection signal, controls the image sensor selectively incorporating with the first light source or the second light source to scan an image associated with the object to be scanned, and when the image sensor receives the radiation beam transmitted at a first location corresponding to the first window, the image sensor outputs a second selection signal in response to the received radiation beam, when the image sensor receives the radiation beam transmitted at a second location corresponding to the second window, the image sensor outputs a third selection signal in response to the received radiation beam;
a processor, disposed in the housing, for processing the image associated with the object to be scanned; and
wherein when the controller controls the image sensor incorporating with the first light source to scan the image associated with the object to be scanned, the controller further, based on the second selection signal or the third selection signal, controls the processor to selectively process the image associated with the object to be scanned in a positive film mode or a negative film mode.

13. The image scanning apparatus of claim 12, wherein the radiation-based signal transmitter transmits the radiation beam in a fixed period.

14. The image scanning apparatus of claim 13, the cover defines a lower surface corresponding to the top surface, the boss protrudes from the lower surface of the cover, and the switching device is disposed on the top surface.

15. The image scanning apparatus of claim 13, wherein the top surface defines a lower surface corresponding to the top surface, the switching device is disposed on the lower surface, and the boss protrudes from the top surface of the housing.

16. A control method for an image scanning apparatus comprising a housing, a cover, a first light source disposed in the cover and a second light source disposed in the housing, said control method comprising the steps of:
(a) judging whether the cover is positioned at a closed position with respect to the housing;
(b) if YES in step (a), controlling the first light source as a scanning light source for said image scanning apparatus, and if NO in step (a), controlling the second light source as the scanning light source for said image scanning apparatus.

17. The control method of claim 19, wherein said image scanning apparatus also comprises a signal transmitter for transmitting an active signal and a signal receiver for selectively receiving the active signal and outputting a first selection signal in response to the received active signal, in step (a), the judgment whether the cover is positioned at the closed position with respect to the housing is performed by judging whether the first selection signal is generated.

18. The control method of claim 17, wherein the signal transmitter is a radiation-based signal transmitter, the active signal is a radiation beam, and the radiation-based signal receiver is radiation-based signal receiver.

19. The control method of claim 18, wherein the radiation-based receiver is an image sensor of said image scanning apparatus, step (b) also performs controlling the image sensor selectively incorporating with the first light source or the second light source to scan an image associated with the object to be scanned.

20. The control method of claim 19, if YES in step (a), further comprising the steps of:
(b-1) judging a location where the image sensor receives the radiation beam transmitted; and
(b-2) according to the result of step (b-1), selecting a corresponding image processing mode, and processing the image associated with the object to be scanned in the corresponding image processing mode.
